(19) United States
(12) Patent Application Publication
(10) Pub. No.: US 2015/0267963 A1
(43) Pub. Date: Sep. 24, 2015

(54) SYSTEMS AND DEVICES FOR FEEDSTOCK PRODUCTION FROM SEWAGE

(71) Applicant: APPLIED CLEANTECH INC., New York, NY (US)

(72) Inventor: Refael Aharon, Maalle Adumim (IL)

(21) Appl. No.: 14/435,179

(22) PCT Filed: Oct. 14, 2013
(86) PCT No.: PCT/IB2013/002474

§ 371 Date: Apr. 13, 2015

Related U.S. Application Data
(60) Provisional application No. 61/713,530, filed on Oct. 14, 2012.
(60) Provisional application No. 61/873,280, filed on Sep. 3, 2013.

(51) Int. Cl. F26B 3/06; F26B 17/20; F26B 15/12

(52) U.S. Cl. CPC F26B 3/06; F26B 15/122; F26B 17/20

(57) ABSTRACT

A drying device for feedstock production from fibers, comprising an inlet for allowing the fibers into the drying device, a rotation assembly configured to move the fibers, a heating assembly configured to provide heat to the fibers for drying thereof. The heating assembly may comprise at least one channel for flow of a heating medium therethrough. There may also be provided a system for feedstock production from flowing sewage, comprising an inlet for flow of the flowing sewage therein, the sewage comprising a solid portion and a liquid portion, the solid portion including fibers, a solid entrapping device for separating the solid portion from the liquid portion, and a drying device configured for drying and moving the solid portion, thereby producing a feedstock.

### CROSS REFERENCE TO RELATED APPLICATIONS

This application claims priority to: U.S. Provisional Patent Application No. 61/713,530, filed Oct. 14, 2012 and entitled “Methods and Systems for Feedstock Production from Sewage and Devices for Performing the same”; U.S. Provisional Patent Application No. 61/873,280, filed Sep. 3, 2013 and entitled “Devices for Feedstock Production from Sewage”. The disclosures of the above applications are incorporated herein by reference in their entireties.

### FIELD OF THE INVENTION

The present invention relates generally to systems and devices for producing feedstock from sewage and more specifically relates to systems and devices for producing cellulosic feedstock from sewage.

### BACKGROUND

Cellulose is an organic compound defined as a polysaccharide structured of a linear chain of several hundred to over ten thousand glucose units.

Fibers comprising cellulose can be found in sewage systems, such as municipal sewage waste systems, industrial waste systems and agricultural waste systems. The source of cellulose fibers in the municipal sewage waste system is typically from fruits and vegetables, vegetation, paper, moist towelettes, cloth, toilet paper, and laundry refuse.

### SUMMARY OF DISCLOSURE

There is provided according to an embodiment of the disclosure, a drying device for feedstock production from fibers, comprising an inlet for allowing the fibers into the drying device, a rotation assembly configured to move the fibers, a heating assembly configured to provide heat to the fibers for drying thereof. The heating assembly may comprise at least one channel for flow of a heating medium therethrough.

The heating assembly and rotation assembly may comprise at least one shaft. The heating assembly and rotation assembly may comprise more than one shaft.

In some embodiments, the drying device may further comprise at least one shaft and a least one disc along the shaft. The disc may be formed with protrusions protruding around a periphery of the disc. A protrusion may be positioned with a different angular displacement relative to another adjacent protrusion. The rotation assembly may further comprise scrapers for scrapping the fibers off the shaft.

In some embodiments, the heating assembly may comprise at least one shaft formed with a bore defining the channel for flow of the heating medium therein. The heating assembly may comprise a housing formed with a layer for flow of the heating medium therein. The heating assembly and rotation assembly may be configured for drying the fibers and moving the fibers simultaneously.

In some embodiments, moving the fibers may comprise at least one of advancing the fibers along the shaft and at least partially rotating the fibers around the shaft. The rotation assembly may be configured to perform at least one of the following: de-clump the fibers therein, stir the fibers therein, refine the fibers therein, and cleave the fibers therein.

In some embodiments, the fibers may be from sewage flowing from a municipal waste water treatment plant. The flowing sewage may comprise a liquid portion of over 90%. The fibers may be dried in the drying device to produce feedstock therefrom. The feedstock may be a cellulosic feedstock containing a cellulose content of at least 70% or more. The feedstock may be a cellulosic feedstock containing a cellulose content in the range of least 50-95% or more. The heating element may be configured to dry the fibers to a dryness degree in the range of approximately 70%-99%.

There is provided according to an embodiment of the disclosure, a system for feedstock production from flowing sewage, comprising an inlet for flow of the flowing sewage therein, the sewage comprising a solid portion and a liquid portion, the solid portion including fibers, a solid entrapping device for separating the solid portion from the liquid portion, and a drying device configured for drying and moving the solid portion, thereby producing a feedstock. The system may further comprise any one of the following: an undesired particle removal device for removal of undesired particles from the flowing sewage, a dewatering device for removal of water from the solid portion, or a pellet machine for forming pellets from the feedstock. The feedstock may comprise a cellulosic content of 20-90% thereof. The feedstock may comprise a cellulosic content of 70-90% thereof. The feedstock may comprise particles with a specific gravity of approximately 1 gram per milliliter or less.

In some embodiments, the feedstock may comprise cellulosic feedstock used to manufacture any one of textiles, combustion products, pellets, chips, fiberboards, plant media, pulp, plastics, plastic fillers, insulation materials, paper, animal feed, animal media, a glucose-containing compound, biofuels, butanol, propane, butane, and ethanol.

In some embodiments, the feedstock may be produced by mechanical processes. The feedstock may be not produced by chemical or biological processes. The feedstock may comprise organic materials. The feedstock may comprise a portion of at least 70% organic materials. The feedstock may be a cellulosic feedstock containing a cellulose content of at least 70% or more.

In some embodiments, the feedstock may be a cellulosic feedstock containing a cellulose content in the range of least 50-95% or more. The system may be adapted to operate in ambient environments of temperatures less than 10° C. without requiring any additional heat to enable operation of the system.

In some embodiments, the drying device may utilize heat for drying the solid portion. The heat may be supplied by combustion of a fraction of the feedstock produced by the system. The solid entrapping device may comprise a netting. The netting may be cleaned by heated water and the water may be heated by heat supplied by combustion of a fraction of the feedstock produced by the system.

In some embodiments, the system may further comprise a heat exchanger and wherein the heat supplied by combustion of a fraction of the feedstock increases a temperature of water flowing into the drying device, the heated drying device water flows into the heat exchanger to increase the temperature of the water for cleaning the netting. The temperature may increase by at least 20-45° C.

In some embodiments, the system may utilize heat for operation thereof, the heat may be supplied by combustion of a fraction of the feedstock produced by the system. The system may utilize heat for operation thereof, the heat may be supplied by combustion of a fraction of the feedstock produced by the system without any additional heat supplied from a source external to the system.

In some embodiments, the system may further comprise a controller and at least one sensor configured to indicate an operational parameter of the system, wherein the controller may be configured to receive signals from the sensor and control the operational parameter of the system. The system may be configured to regulate incoming sewage at an inconsistent rate to flow in the drying device at a consistent rate.

In some embodiments, the system may further comprise a flow control subassembly comprising a plurality of spaced apart plates configured for flow of sewage in between the plates. The system may further comprise a flow control subassembly comprising a plurality of spaced apart plates configured for reducing turbulence of the sewage flowing out of the flow control subassembly. The system may further comprise a reservoir for storing a solid portion therein and a pump for directing the solid portion from the reservoir to the drying device.

In some embodiments, the drying device may comprise at least one shaft. The drying device may comprise more than one shaft. The drying device may comprise at least one shaft and a least one disc along the shaft. The disc may be formed with protrusions protruding around a periphery of the disc. The protrusion may be positioned with a different angular displacement relative to another adjacent protrusion. The drying device comprises scrapers. The drying device may comprise at least one shaft formed with a bore for flow of a heated medium therein. The drying device may comprise a housing formed with a layer for flow of a heating medium therein. The drying device may be configured for drying and moving the solid portion simultaneously. Moving the solid portion may comprise at least one of advancing the solid portion along the shaft or at least partially rotating the solid portion around the shaft.

In some embodiments, the rotation assembly may be configured to perform at least one of the following to fibers within the solid portion de-clump the fibers therein, stir the fibers therein, refine the fibers therein, and cleave the fibers therein.

In some embodiments, the flowing sewage may be sewage flowing from a municipal waste water treatment plant. The flowing sewage may comprise a liquid portion of over 90%.

There is provided according to an embodiment of the disclosure, a method for producing feedstock from sewage, comprising providing sewage, the sewage may comprise a solid portion and a liquid portion, the solid portion may include fibers, separating the solid portion from the liquid portion, and drying the solid portion and moving the solid portion, thereby producing a feedstock.

### BRIEF DESCRIPTION OF THE DRAWINGS

The principles and operations of the systems, apparatuses and methods according to some embodiments of the present disclosure may be better understood with reference to the drawings, and the following description. These drawings are given for illustrative purposes only and are not meant to be limiting.

FIG. 1 is a schematic illustration of an exemplary system for producing cellulosic feedstock from sewage, constructed and operative according to an embodiment of the present disclosure;

FIG. 2 is a pictorial illustration of an exemplary system for producing cellulosic feedstock from sewage, constructed and operative according to an embodiment of the present disclosure;

FIG. 3A is a sectional illustration of an exemplary particle entrapping device of the system for producing cellulosic feedstock from sewage of FIG. 2, constructed and operative according to an embodiment of the present disclosure;

FIG. 3B is a cut-away illustration of an exemplary flow control subassembly associated with the particle entrapping device;

FIG. 4 is a pictorial illustration of a drying device of the system for producing cellulosic feedstock from sewage of FIG. 2, shown in an oppositely facing orientation relative to the drying device shown in FIG. 2;

FIG. 5 is a pictorial illustration of an exemplary pellet machine and a portion of a thermal transfer assembly of the system for producing cellulosic feedstock from sewage of FIG. 2, constructed and operative according to an embodiment of the present disclosure; and

FIG. 6 is a pictorial illustration of a portion of the thermal transfer assembly of the system for producing cellulosic feedstock from sewage of FIG. 2, constructed and operative according to an embodiment of the present disclosure.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

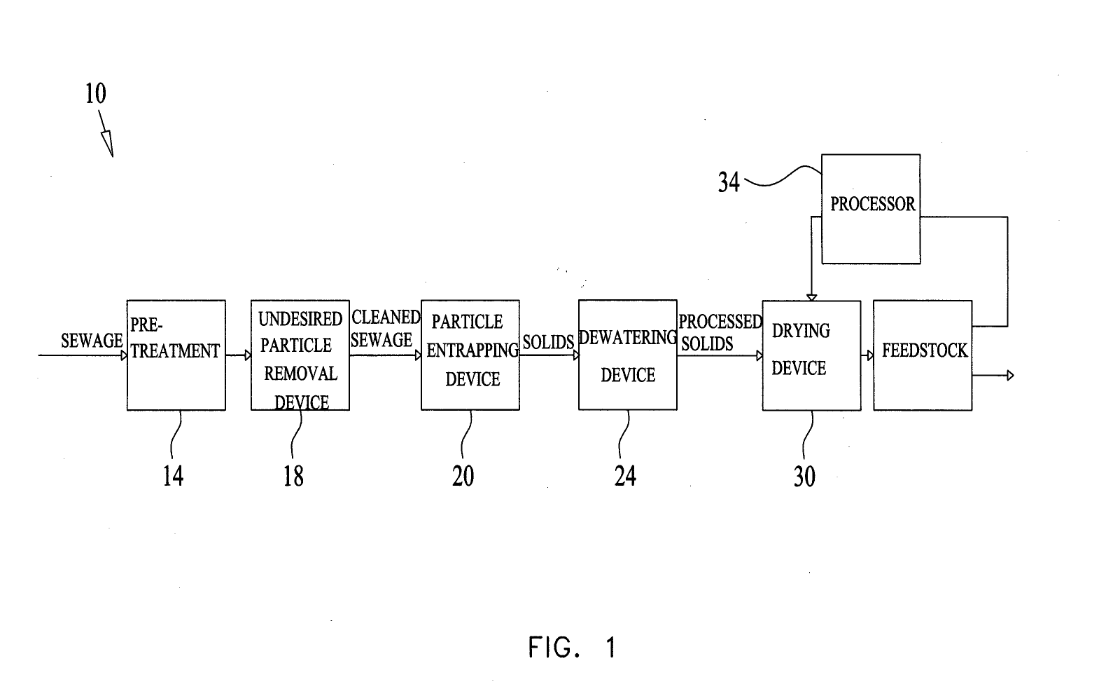

Reference is now made to FIG. 1, which is a schematic diagram of an exemplary sewage feedstock system 10 for producing cellulosic feedstock from sewage, constructed and operative in accordance with an embodiment of the present disclosure.

In accordance with some embodiments, the sewage may be raw sewage. Raw sewage may be defined as sewage flowing within a sewerage waste system prior to standard wastewater treatment thereof. Standard wastewater treatment may comprise sedimentation, aeration and/or digestion of the sewage. The sewerage waste system may comprise a Wastewater Treatment Plant (WWTP), a municipal sewage waste system or any other sewage waste system, such as, for example, an industrial and/or an agricultural waste system. Raw sewage of the municipal sewage waste system may include a suspension comprising a liquid portion in a range of approximately 25-99.99% and a solid portion in a range of approximately 0.01-75% thereof. In some embodiments, such as in some municipal WWTP the raw sewage comprises a liquid portion of over 90%. In some embodiments, such as in some municipal WWTP the raw sewage comprises a liquid portion of over 70%. In some embodiments, such as in some municipal WWTP the raw sewage comprises a liquid portion of over 50%.

The solid portion may be partially suspended within the liquid portion and partially solved therein. In raw sewage the solid portion may include a 50% soluble solid portion and a 50% suspended solid portion. The liquid portion may include water, soluble organic matter, minerals, oils and other materials. The suspended solid portion of raw sewage may include an aggregate of particles. The particles may comprise a homogenous portion and/or a heterogeneous portion of the solid portion of the sewage. Exemplary particles may contain a cellulose (i.e. fiber) content of 20-90% thereof; a hemicellulose content of 1-35% thereof; a lignin content of less than 20% thereof; a nitrogen containing organic compound content of up to 20% thereof; a protein containing organic compound content of up to 20% thereof; a mineral content of less than 15% thereof; a sand content of less than 15% thereof and a dirt content of less than 30% thereof and other sewage refuse. The solid portion may also include oil and water adsorbed to the particles. In certain aspects of the raw sewage, the solid portion of raw sewage may include less than 15% of oil therein. The portion percentages of the particles may be measured as the dry weight of the solid portion.

In certain embodiments of the disclosure, the term “oil” may include oleaginous matter such as grease, fats and oils.

In accordance with some embodiments, the sewage entering the sewage feedstock system 10 may be treated sewage, typically treated by a standard wastewater treatment process, such as sedimentation, or aeration or any other process, though the sewage may not be treated by digestion, which digests the sewage into sludge. The raw or treated sewage may be effused into the sewage feedstock system 10 from a main pipeline at the entrance of a sewage waste system, a WWTP or any location within the WWTP prior to digestion of the sewage therein.

Initially, the sewage (which may include raw sewage or treated sewage prior to digestion thereof) may be introduced into a pretreatment device 14 for removing crude, insoluble dirt, such as large rocks and plastic chunks. Exemplary crude, insoluble dirt, such as large rocks and plastic chunks may have a diameter larger than 5-7 millimeters. The pretreatment device may comprise any suitable device, such as a screen, a step screen, a sifter, or a filter.

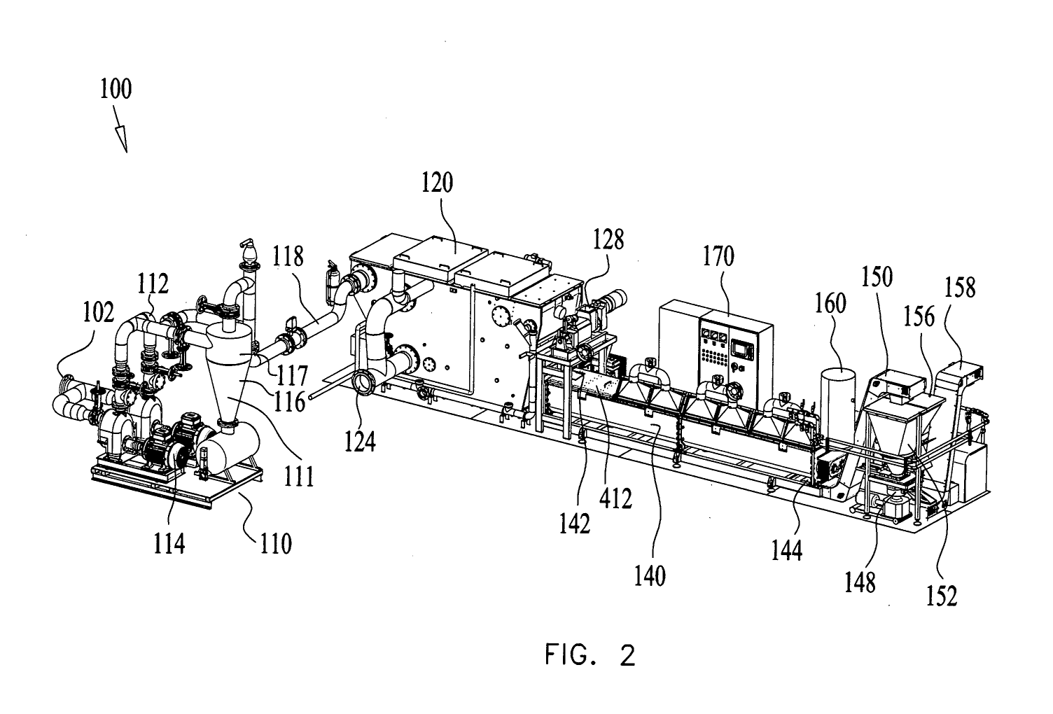

The sewage feedstock system 10 may comprise an undesired particle removal device 18 configured in any suitable manner for removing undesired particles, from the sewage, such as sand and dirt, including iron, steel, dust, metals, rocks, and plastic particles. The undesired particle removal device 18 may comprise a sand removal device 110, described in reference to FIG. 2 or any other means for removing the undesired particles, such as by sedimentation performed by centrifugation, such as hydrocyclonic centrifugation, vibration or ultrasonic sedimentation or by screens or filters.

In some embodiments the undesired particle removal device 18 may be obviated.

The pretreatment device 14 and the undesired particle removal device 18 may be configured to remove particles with or greater than a predetermined specific gravity.

In some embodiments, the undesired particle may comprise particles with a specific gravity higher than approximately 2 grams per milliliter. Such an undesired particle may be sand or rocks, which have a specific gravity of 3 grams per milliliter or metal which has a specific gravity of 7 grams per milliliter.

The desired particles of the sewage, which are further processed in the sewage feedstock system 10 may comprise particles with a specific gravity less than approximately 2 grams per milliliter. In some embodiments the desired particle may comprise particles with a specific gravity of approximately 1 gram per milliliter or less, including soluble and insoluble solids.

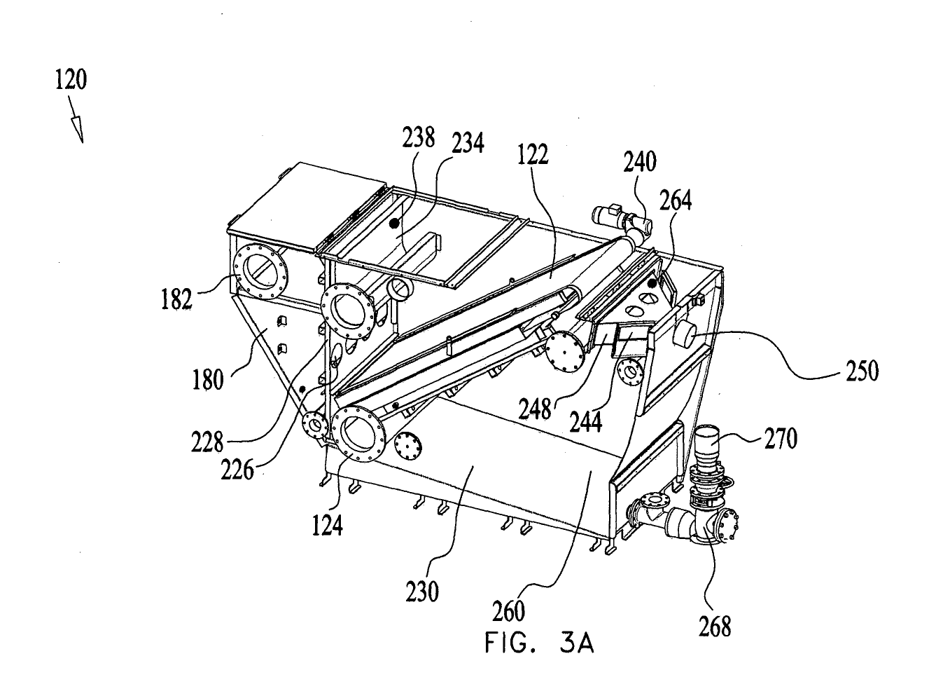

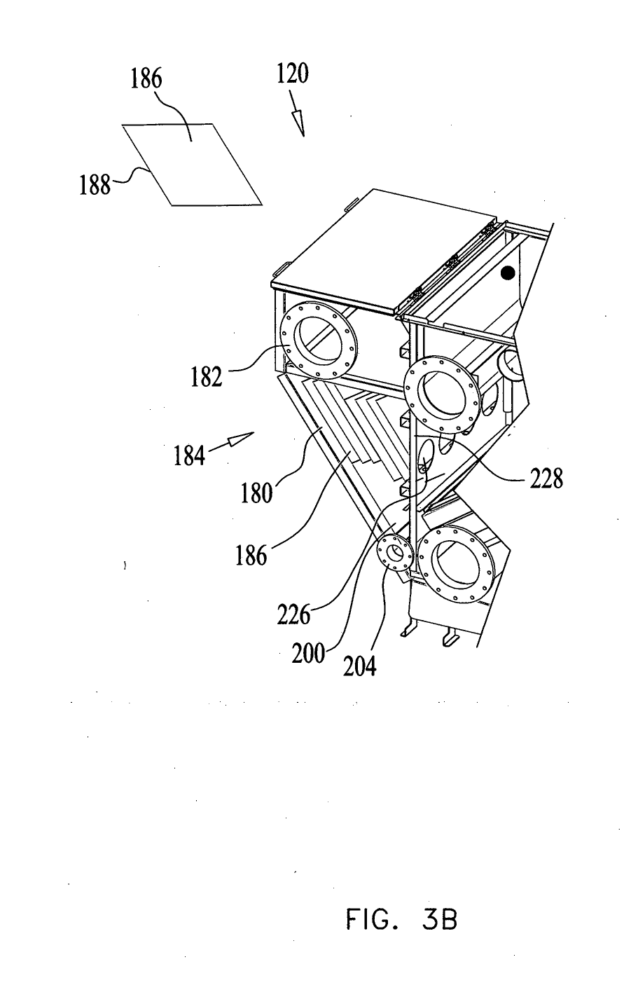

The now cleaned sewage may flow to a solid entrapping device 20 configured in any suitable manner for trapping the solid portion from the cleaned sewage and thus separating the solid portion from the liquid portion. The solid entrapping device 20 may comprise the solid entrapping device 120, described in reference to FIGS. 2 and 3A.

The liquid portion may be discarded or may flow to a sewage management system, such as back to the WWTP.

The solid portion originating from the sewage may be processed for producing cellulosic feedstock therefrom.

The processing of the solid portion may comprise dewatering in a dewatering device 24 configured in any suitable manner. The dewatering device 24 may comprise the dewatering device 128, described in reference to FIG. 2. In some embodiments the dewatering device 128 may be obviated.

The processed solid portion may thereafter be introduced into a drying device 30. The drying device 30 may be configured to dry the processed solid portion as well as move the solid portion for preparing it to be used as feedstock. The drying device 30 may be configured to dry the processed solid portion. In some embodiments the drying device 30 may be used to de-clump the solid portion for preparing it to be used as feedstock. In some embodiments the drying device 30 may be configured to cleave the processed solid portion. The cleaved processed solid portion may comprise cleaving relatively large solids, such as branches, cloths or moist towelettes, for example. In some embodiments the drying device 30 may be configured to stir the solid portion so as to produce a homogenous mixture.

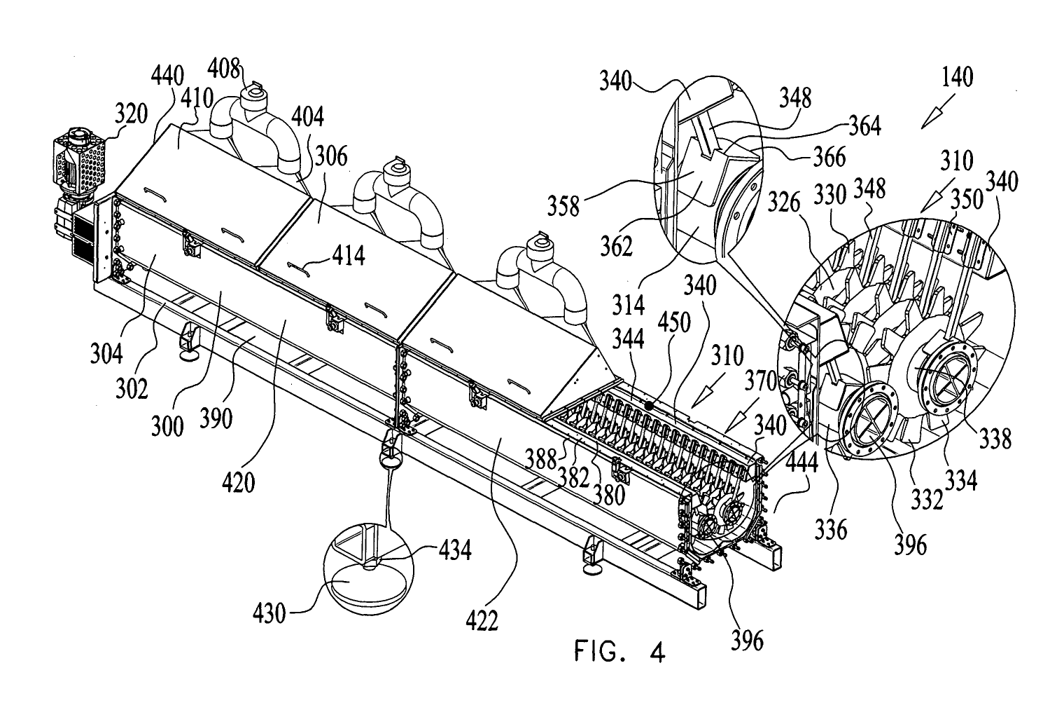

In some embodiments the drying device 30 may comprise the drying device 140, described in reference to FIGS. 2 and 4. In some embodiments the drying device 30 may comprise heaters, such as radiators, ovens or furnaces or heat exchangers. The drying device 30 may employ any suitable method for drying, such as evaporation employing heat treatment, such as solar heat or placing the solid portion in a greenhouse, cryogenic treatment, vacuum, a press, such as a screw press, a drum dryer, blowers blowing a hot fluid over or through the solid portion or a combination thereof. The dried processed solid portion may be used as feedstock. A fraction of the feedstock may be further processed in a processor 34 and may be used as feedstock by the sewage feedstock system 10. For example, the drying device 140 may use heat provided by combusted feedstock processed by the processor 34 comprising an oven 510, described in reference to FIGS. 2-6.

The feedstock produced from sewage may be cellulosic feedstock comprising a high cellulosic content. In a non limiting example, cellulosic feedstock produced from corn contains a 37.4% cellulosic portion of the dry weight, while relatively high cellulose content in the cellulosic feedstock produced from sewage by the systems and methods of the disclosure is at least 50% of the dry weight or more. In some embodiments, the cellulose content in the cellulosic feedstock produced from sewage by the systems and methods of the disclosure is at least 80% of the dry weight or more. In some embodiments, the cellulose content in the cellulosic feedstock produced from sewage by the systems and methods of the disclosure is at least 90% of the dry weight or more. In some embodiments, the cellulose content in the cellulosic feedstock produced from sewage by the systems and methods of the disclosure is at least 95% of the dry weight or more.

Cellulosic feedstock may be used to manufacture a plurality of materials, including, but not limited to: textiles; combustion products, such as pellets or chips; fiberboards; plant media; pulp; plastics; plastic fillers; fillers for any material, insulation materials; paper; animal feed; animal media, a glucose-containing compound and biofuels, such as butanol, propane, butane, and ethanol.

In a non-limiting example, the cellulosic feedstock may include a composition comprising, consisting essentially of, or consisting of an oil content of up to 15% thereof; a cellulose content of 40-99% thereof; a hemicellulose content of 2-20% thereof; a lignin content of less than 15% thereof; a nitrogen containing organic compound content of up to 20% thereof; a protein containing organic compound content of up to 20% thereof; a mineral content of less than 5% thereof; a sand content of less than 5% thereof and a dirt content of less than 25% thereof.

In a non-limiting example, a yield of 1 ton of cellulose of the solid portion may be obtained from processing 3300 m³ of sewage within the sewage feedstock system 10 and an amount of 15,000 m³ of cellulose of the solid portion may be obtained per day.

In a non-limiting example, the cellulosic feedstock may comprise, consist essentially of or consist of particles with a size of 0.01 μm-500 mm.

In a non-limiting example, the caloric value of the cellulosic feedstock may be in the range of 5000-16000 British Thermal Units (BTU)/Pound.

The cellulosic feedstock according to the systems and methods of the disclosure provides for a plurality of superior benefits. For example, the cellulosic feedstock produced by the systems and methods of the disclosure has relatively less lignin when compared with solids retrieved from vegetative sources, such as, wood, wheat and corn. In a non-limiting example, cellulosic feedstock produced by the systems and methods of the disclosure contains 30%-60% less lignin than solids retrieved from corn. The decreased lignin content of the cellulosic feedstock produced by the systems and methods of the disclosure is advantageous in production of a paper product from the cellulosic feedstock because the quality of the paper product increases as the lignin volume of the paper product decreases.

An additional benefit is that fibers of the cellulosic feedstock produced by the systems and methods of the disclosure have a larger total surface area than fibers retrieved from vegetative sources. The larger total surface area of fibers within the cellulosic feedstock produced by the systems and methods of the disclosure results from the disintegration of the fibers within the sewage as well as the cleaving and/or stirring of fibers within the drying device 30 or drying device 140. A relatively large fiber surface area increases contact with processing materials, including, but not limited to, a hydrochloric acid wash for manufacturing products from the cellulosic feedstock.

Another benefit is that fibers of cellulosic feedstock produced by the systems and methods of the disclosure have a relatively high cellulose content thus allowing for production of high quality products therefrom. For example, ethanol, which comprises mainly cellulose, may be produced from the cellulosic feedstock. As described above, the relatively high cellulose content in the cellulosic feedstock produced of sewage by the systems and methods of the disclosure may in the range of at least 50-95% more of the dry weight.

Conventionally, following treatment of sewage in a wastewater management system, typically a WWTP, the volume of solids within the sewage is reduced. For example, following a conventional treatment, the volume of solids within the sewage is reduced by 30-40% due to processing within a digestion tank in the WWTP. Processing of sewage produces sludge. Typically, sludge is disposed of by drying and landfilling thereafter.

According to an embodiment of the present disclosure the solid portion of the sewage is removed from sewage prior to entering the digestion tank within the WWTP. In some embodiments, removal of the solid portion from sewage may be performed prior to entering a primary sedimentation tank within the WWTP. This allows for maximal removal of the solid portion from sewage prior to settling of solids within the sedimentation tank.

In accordance with the systems and methods of the disclosure, removal of the solid portion from the sewage decreases the volume of the solid portion to be digested or processed within the WWTP. For example, introducing sewage into the sewage feedstock system 10 may reduce the solid portion of the sewage by approximately 30-50%. Thus, removing the solids from the sewage according to the systems and methods of the disclosure provides an additional benefit by decreasing the solid volume to be processed within the WWTP.

By employing the sewage feedstock system 10, a substantial portion of digestion-resistant components, such as cellulose, minerals and sand, present within the suspended solid portion of the sewage (raw or treated) are removed. In some embodiments, this digestion-resistant portion may comprise at least 10%-90% or more of the suspended solid portion. In some embodiments, this digestion-resistant portion may comprise at least 10% or more of the suspended solid portion. In some embodiments, this digestion-resistant portion may comprise at least 30% or more of the suspended solid portion. In some embodiments, this digestion-resistant portion may comprise at least 50% or more of the suspended solid portion. In some embodiments, this digestion-resistant portion may comprise at least 70% or more of the suspended solid portion. In some embodiments, this digestion-resistant portion may comprise at least 90% or more of the suspended solid portion. Removal of the digestion-resistant components of sewage (raw or treated) prior to digesting the sewage provides for increased digestion efficiency. Consequently, the systems and methods of the disclosure produce a substantially decreased volume of sludge when compared to the volume of sludge produced within a standard WWTP. In a non-limiting example, the systems and methods of the disclosure increase the digestion efficiency of sewage (raw or treated), thus producing approximately half of the volume of sludge produced by a conventional digestion method employed within a standard WWTP.

Another further benefit for producing feedstock by the systems and methods of the disclosure is that according to some embodiments the sewage is processed by mechanical processes only, such as any one of: heating stirring, rotating, cleaving and/or pressing. Thus the feedstock is produced without chemical treatments or biological treatments. A chemical treatment comprises treatment with chemicals. A biological treatment comprises treatment with microorganism, microbes and the like. The feedstock, and specifically the cellulosic feedstock, produced by mechanical processes is intrinsically different than chemically or biologically produced feedstock since the properties of the solid portion from the sewage remain intact. For example, in a chemical process comprising hydrolysis, the fibers of the solid portion of the sewage are broken down, thereby transforming the cellulose into glucose and thus altering the properties of the feedstock. In a biological process comprising anaerobic digestion, the cellulose is digested by the microorganism, thereby reducing the cellulosic content of the feedstock.

Moreover, the feedstock produced by mechanical processes remains an organic material, while chemically or biologically processing the sewage transforms the organic solids (e.g. cellulose) into inorganic materials. In a non-limiting example the feedstock comprises a portion if at least 60% organic materials. In a non-limiting example the feedstock comprises a portion if at least 70% organic materials. In a non-limiting example the feedstock comprises a portion if at least 80% organic materials. In a non-limiting example the feedstock comprises a portion if at least 90% organic materials.

An additional benefit to producing the feedstock by mechanical processes is the elimination of use of ecologically harmful chemicals, thus the method and system of the disclosure is more environmentally friendly then feedstock produced by use of chemicals.

Furthermore, standard treatment of sewage includes biological treatments. The biological treatment comprises digestion of the sewage by bacteria, which emit carbon dioxide and other hazardous gases during digestion. In accordance with the system and method of the disclosure, the sewage is treated in the sewage feedstock system 10. Hence, treating the sewage by mechanical processes eliminates emission of hazardous gases. In some embodiments, the carbon dioxide emitted during treating the sewage according to the systems and methods of the disclosure, is reduced significantly since most of the organic materials of the solid portion remain organic.

Additionally, digestion of the sewage cannot be performed at low ambient temperatures, such as below 0° C. To perform digestion in cold climates heat is provided to enable the digestion. Yet by treating the sewage mechanically within the sewage feedstock system 10 the treatment is not dependent on the ambient temperatures and may be performed under various environmental conditions. Thus the system of the disclosure is adapted to operate in ambient environments of temperatures less than 10° C. and even less than 0° C. without requiring any additional heat to enable operation of the system.

Moreover, to perform the digestion of the sewage a high degree of heat must be provided for ensuring effective digestion, such as in a cold climate with a low temperature ambient environment. Yet by treating the sewage mechanically within the sewage feedstock system 10 a significantly lesser degree of heat is required. In a non-limiting example, the amount of heat required to heat the environment of the WWTP to enable digestion of sewage with a solid portion of 25 kilos in a standard WWTP employing digestion, is 3 kWh. This energetic investment is made redundant by treating the sewage according to the systems and methods of the disclosure.

The sewage feedstock system 10 may be configured in any suitable manner, including any suitable components operating in any suitable order or sequence. In a non-limiting example the sewage feedstock system 10 may be configured as a sewage feedstock system 100 described in reference to FIGS. 2-6.

Reference is made to FIG. 2, which is an exemplary pictorial illustration of the sewage feedstock system 100. As seen in FIG. 2, the sewage (raw or treated prior to digestion thereof) may flow into the sewage feedstock system 100 via an entrance pipe 102 or by any other suitable means for introducing the flowing sewage therein.

The sewage may be introduced into the pretreatment device 14 described in FIG. 1.

The sewage may be introduced into a sand removal device 110 designed to remove sand or various small particles from the sewage by any suitable means. For example, sand may be removed from the sewage by sedimentation performed by centrifugation, such as a hydrocyclone, centrifugation, vibration or ultrasonic sedimentation. The sediment may be discarded by any suitable means, such as via pipes directing the sediment out of the sewage feedstock system 100.

As seen in FIG. 2, the sand removal device 110 may comprise a hydrocyclone 111 along with an assembly of pipes 112 and pumps 114 for operation thereof. The hydrocyclone 111 may comprise a conical portion 116 extending from a cylindrical portion 117. The hydrocyclone 111 is configured to classify, separate or sort particles in a liquid suspension based on the ratio of their centripetal force to fluid resistance. The quantity of sand and other particles within the sewage may vary in accordance with the climate of the sewage waste system location.

In some embodiments, the sand removal device 110 may be obviated and the sewage may flow into the sewage feedstock system 100 without sand removal therefrom.

The sand removal device 110 may also remove other small undesired particles, such as dirt including iron, steel, metals dust, rocks and plastic particles. In some embodiments, the undesired particle may comprise particles with a specific gravity higher than approximately 2 grams per milliliter.

In some embodiments, lighter dirt components, such as but not limited to dust, may be removed by sedimentation as described hereinabove, or by suspending the dirt components and thereafter discarding the dirt suspension from the sand removal device 110. Components of dirt that may be considered heavier, including, but not limited to metals, may be removed by sedimentation.

The now cleaned sewage may flow out of the sand removal device 110, via a pipe 118, to a solid entrapping device 120 configured to entrap and separate the solid portion from the liquid portion of the cleaned sewage.

In some embodiments, the solid entrapping device 120 may comprise a single net or a multiplicity of nettings 122 (FIG. 3A) for entrapping the solid portion of sewage. The multiplicity of nettings 122 may be a series of nettings wherein each subsequent netting may be formed with apertures of a smaller size than the previous netting to provide additional trapping of solid particles from the sewage. The mesh size of the netting 122 is designed to trap a desired size of the solids. In some embodiments, the netting 122 may be formed with a mesh size configured to trap solids with an average diameter of 0.01 μm-100 mm or 01 μm-500 mm.

The netting 122 may be formed in any suitable configuration for trapping the solid portion and may be formed of any suitable material for flow of the sewage therethrough, such as a corrosive resistive material and/or a high pressure resistive material, typically aluminum, for example.

The solid entrapment may be achieved in any suitable manner, such as by separation with conveyor belts formed of conveyor belt mesh, centrifugation, such as flow centrifugation or a hydrocyclone, for example, separation by screw presses, separation by use of vibration in a vibration separator, filtering by disk filters, filter presses, media filters, such as filters containing fibers, for example, biological filters, such as filters containing cellulose, for example, chemical filters, such as filters containing silica, for example, a filter employing backflushing technology, or any other suitable manner for entrapping solids from the sewage.

A backflushing filter may comprise a screen or a filtration media operative to filter solids such that solids accumulate on a first surface of the screen or filtration media. Liquid is urged to flow from an opposite surface of the screen or filtration media to the first surface thereof. This reverse flow of liquid through the screen or filtration media is used for removing solids accumulated on the screen or filtration media during the filtration process. According to the systems and methods of the disclosure, the liquid described above may include, but is not limited to, water.

A residual, liquid portion is discharged from solid entrapping device 120 via an outlet 124 or any suitable means. The liquid portion comprises the liquid portion of the sewage and may additionally comprise relatively small solid particles, typically particles with a size of less than approximately 0.01-80 μm. In some embodiments, the liquid portion may be discarded or may flow to a wastewater management system, such as back to the WWTP in any suitable manner, e.g. by conduits. In some embodiments, the liquid portion may be introduced into an additional feedstock production system (not shown) for producing additional feedstock from the sewage.

In certain embodiments of the systems and methods of the disclosure, the liquid portion is approximately 80-95% of the raw sewage entering the sewage feedstock system 100. The remaining portion, typically 5-20% of the raw sewage entering the sewage feedstock system 100, is a solid portion.

The solid portion is comprised of solid particles and liquids adsorbed to the solid particles, such as oils and water.

In some embodiments, the solid particles of the solid portion exceed a size of approximately 0.01 μm. In some embodiments, the solid particles of the solid portion exceed a size of approximately 80 μm. In some embodiments, the solid particles of the solid portion exceed a size of approximately 100 μm. In some embodiments, the solid particles of the solid portion exceed a size of approximately 300 μm.

It is noted that the term “size” described throughout the disclosure may include any applicable parameter, such as a particle length or a particle diameter, for example.

In some embodiments, the solid entrapping device 120 may comprise additional components, as further described in FIGS. 3A and 3B.

The solid portion originating from the sewage may be processed for producing cellulosic feedstock therefrom.

The processing of the solid portion may comprise dewatering in a dewatering device 128 for removing a portion of water from the solid portion. Dewatering device 128 may employ any suitable method for removing water from the solid portion, such as by evaporation by employing heat treatment, such as use of solar heat or greenhouse heat, for example, cryogenic treatment, a vacuum, a press, such as a screw press, a drum dryer or a combination thereof.

In some embodiments, the dewatering device 128 may be obviated.

In some embodiments, the dryness degree of the solid portion exiting the dewatering device 128 is approximately 4-30%.

The processed solid portion may be introduced thereafter into a drying device 140 via an inlet 142.

The drying device 140 may comprise any suitable configuration for drying the processed solid portion. An exemplary drying device 140 is described in reference to FIG. 4. In some embodiments the drying device 140 may comprise heaters, such as radiators, ovens or furnaces. The drying device 140 may employ any suitable method for drying, such as evaporation employing heat treatment, such as solar heat or placing the solid portion in a greenhouse, cryogenic treatment, vacuum, a press, such as a screw press, a drum dryer a blower blowing hot fluid over or through the processed solid portion or a combination thereof.

The processed solid portion exits the drying device 140 at a relatively high degree of dryness and may exit from an outlet 144. In some embodiments, the processed solid portion exits the drying device 140 at a relatively high degree of dryness, i.e., when the solid portion is more than 80% dry. In some embodiments, the processed solid portion exits the drying device 140 at a dryness degree of more than 90%. In some embodiments, the processed solid portion exits the drying device 140 at a dryness degree of more than 95%.

The processed solid portion exiting the drying device 140 may be used as feedstock.

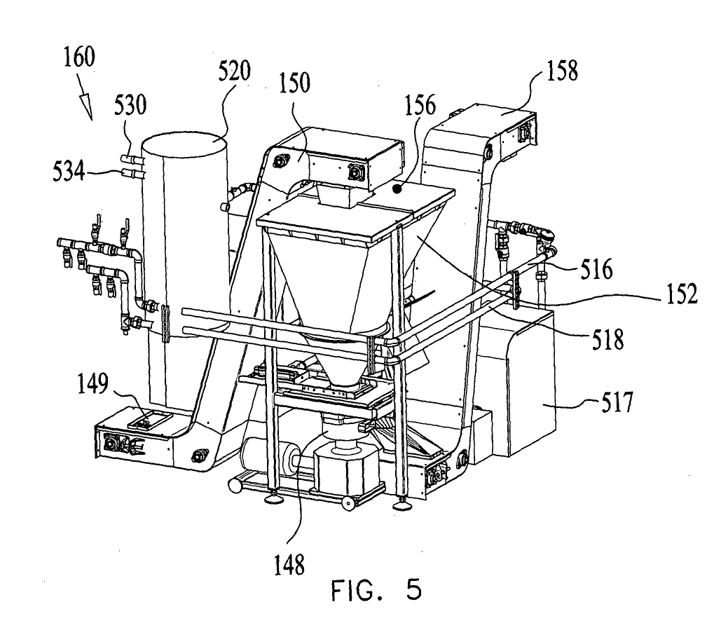

In some embodiments, the solid portion exiting the drying device 140 may be introduced into a pellet machine 148 for producing pellets from the solid portion fed therein. The solid portion may exit the outlet 144 and pour into an inlet 149 (FIG. 5) of a conveyer 150. The solid portion may be introduced into the pellet machine 148 via the conveyer 150 which pours the solid portion into a chute 152. In some embodiments, a sensor 156 may be placed at the chute 152 or any other suitable location for measuring the amount of the solid portion poured therein and accordingly operating the pellet machine 148 and/or drying device 140. For example, the pellet machine 148 may be operated upon receiving a signal from the sensor 156 that the solid portion reached a predetermined amount or height within the chute 152. When the solid portion is below the predetermined amount or height the operation of the pellet machine 148 may be terminated. Similarly, when the solid portion is below the predetermined amount or height the operation of the drying device 140 may be terminated.

It is noted that sensor 156 or any other sensor in the sewage feedstock system 100 may comprise any suitable sensing configuration such as a weight sensor, a volume sensor, a height or level sensor, a temperature sensor, a humidity sensor and/or a motion sensor, for example.

The pellets may exit the pellet machine 148 via a conveyer 158 or any other suitable manner for exit of the pellets.

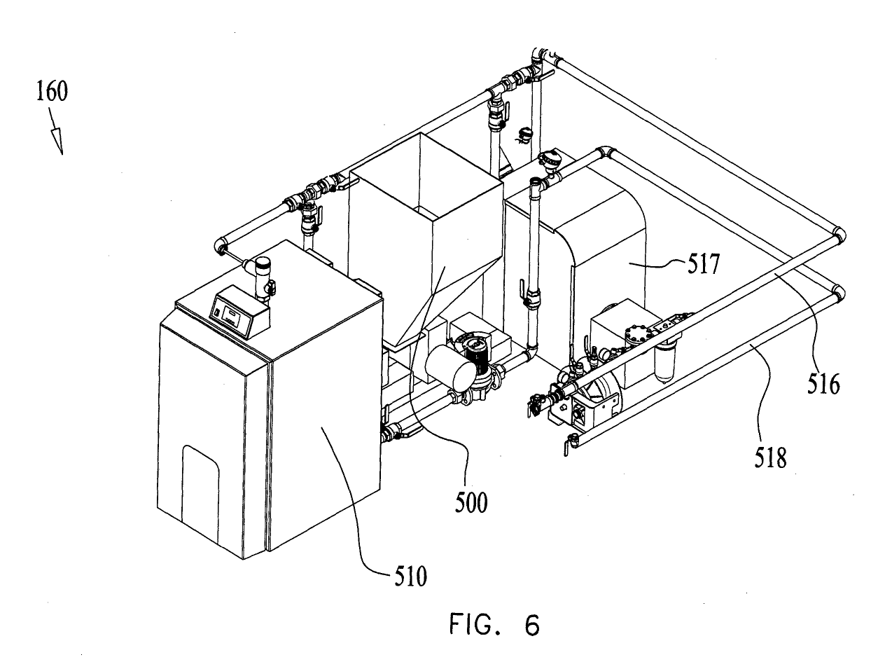

In some embodiments, a fraction of the pellets may be directed from conveyer 158 to a heat transfer assembly 160 for producing thermal energy to be provided to components of the sewage feedstock system 100, such as the drying device 140 (for example, as described in FIGS. 5 and 6). In some embodiments the fraction of the pellets directed to the heat transfer assembly 160 is in the range of approximately 5-20% of the pellets exiting the pellet machine 148.

The remaining fraction of the pellets may be directed from conveyer 158 to a feedstock container for use thereof as cellulosic feedstock in any suitable manner.

In some embodiments, the heat transfer assembly 160 may be obviated. Should the heat transfer assembly 160 be obviated, either a portion or the entirety of pellets may be directed to the feedstock container.

In some embodiments, the solid portion may be introduced into the feedstock container prior to entering the pellet machine 148, from the conveyer 150 or any suitable location within the sewage feedstock system 100, typically comprising a loose, granular consistency. In a non-limiting example, the average volumetric density of the processed solid portion exiting the drying device 140 is with an average volumetric density of 0.1-0.3 grams/milliliter.

A blower may be provided within the sewage feedstock system 100 to provide fluid pressure to ensure the conveyers 150 and 158 and any other components, move the solid portion within the sewage feedstock system 100. Additional blowers may be provided within the sewage feedstock system 100 for flushing the drying device 140 with air for removing humidity from the drying device 140.

Additional devices may be included in the sewage feedstock system 100. For example, the solid portion may be introduced into a sterilizing device for sterilizing the solid portion. The sterilizing device may employ any suitable method for sterilizing the solid portion, such as using heat, such as steam sterilization, UV sterilization, for example. Alternatively, the solid portion may be partially sterilized, such as by being introduced into a pasteurization device for pasteurizing the solid portion.

In some embodiments, the solid portion may be introduced into a mineral removal device for removal of minerals, typically ash and salts, therefrom, by any suitable means for removing minerals. For example, minerals may be removed by washing the solid portion, such as by washing with a cleansing water wash, and/or use of steam or heat. In some embodiments, the minerals may be removed within the sand removal device 110 which is operative to remove small particles.

Iron and or steel or any metal may be removed by any suitable means, such as by utilizing a magnet which attracts the metal thereto thus removing a portion of the metal from the sewage. The magnet may be placed after the drying device 140 or any other suitable location within the sewage feedstock system 100.

Control functionality as well as data collecting and processing functionality may be embodied in processors and electric boards or any other suitable controller 170 of the sewage feedstock system 100. The controller 170 may control various parameters of the operation of the sewage feedstock system 100, such as the duration, speed, temperature etc. the solid portion is processed in any one of the devices within the sewage feedstock system 100. Sensors may be placed within the sewage feedstock system 100 and may communicate with the controller 170 for controlling the operation of the sewage feedstock system 100. An example of a sensor is the chute sensor 156. It is noted that in addition to the sensors explicitly described in this disclosure, additional sensors or other control elements and electrical connections may be provided for producing the feedstock within the sewage feedstock system 100.

Data comprising various parameters of the sewage and solid portion, such as the amount of sewage introduced into the sewage feedstock system 100, may be collected by the data collecting and processing functionality.

As seen in FIG. 2, the control functionality and data collecting and processing functionality may be located within controller 170 within the sewage feedstock system 100. In another embodiment, the control functionality and data collecting and processing functionality may be placed at a remote location and the operation of the sewage feedstock system 100 may be controlled remotely by a human operator or processor (e.g. controlled automatically by, for instance, a computer). Remote control of the system operation enables placement of the sewage feedstock system 100 at a plurality of locations around the world.

Reference is now made to FIGS. 3A and 3B, which depict a sectional illustration of the solid entrapping device 120 and a cut-away illustration of an exemplary flow control subassembly associated with the solid entrapping device 120.

In some embodiments, the solid entrapping device 120 may comprise a flow entrance chamber 180 for receiving the sewage from the pipe 118 (FIG. 2) via an inlet 182. In some embodiments, the flow entrance chamber 180 may comprise a flow control subassembly 184 (FIG. 3B) provided to control the sewage flow prior to flowing to the netting 122, in any suitable manner.

As seen in FIG. 3B, the flow control subassembly 184 may comprise a plurality of spaced apart plates 186. Each plate 186 may be formed in a diamond-like shape with an inclined edge 188. In a non-limiting example the edge 188 may be formed with approximately a 120 degree incline. An exemplary plate 186 is shown removed from the flow entrance chamber 180.

The sewage may flow into the flow control subassembly 184 via inlet 182. The sewage flows downwardly intermediate the plurality of plates 186. This flow pattern intermediate the plurality of plates 186 increases the surface contact the sewage flow has with the plates 186 as opposed to the surface contact with a standard pipe. In a non-limiting example, the surface contact of the sewage flow with the plates 186 of the flow control subassembly 184 may be 20 times greater than the surface contact with a standard pipe.

The increased surface contact regulates and reduces the velocity of the sewage flow, thereby reducing flow turbulence, which may be caused by colliding flow currents. Additionally, forcing the sewage to flow intermediate the plates 186 causes dirt and sand within the sewage to settle at a bottom portion 200 of the flow entrance chamber 180. The now settled sand and dirt may be discarded from the flow control subassembly 184 in any suitable manner, such as via an outlet 204 and out of the sewage feedstock system 100.

An additional advantage of the flow control subassembly 184 is the removal of sand and dirt or any other small particles from the sewage flow. This reduces the turbulence of the sewage flow. Substantially laminar flow of sewage through the netting 122 ensures the sewage will flow through apertures of the netting 122. Removal of small particles from the sewage flow reduces the clogging of the netting 122 during the sewage flow therethrough.

In a non-limiting example, the small particles may comprise a specific gravity in the range of approximately 2-20 grams per milliliter. In a non-limiting example, the small particles may comprise a specific gravity in the range of approximately 2-10 grams per milliliter.

In a non-limiting example the substantially laminar flow may flow with a Reynolds number less than 3000. In a non-limiting example the substantially laminar flow may flow with a Reynolds number less than 4000. In a non-limiting example the substantially laminar flow may flow with a Reynolds number less than 5000.

The sewage may flow out of the flow entrance chamber 180 through a single or plurality of inlets 226 formed in a partition wall 228 separating the flow entrance chamber 180 from a solid entrapping enclosure 230.

In some embodiments, the solid entrapping enclosure 230 may comprise an overflow control duct 234 configured to direct the sewage flow out of the solid entrapping enclosure 230 at times the sewage flow reaches a predetermined level. The predetermined level may be measured by a sensor 238 placed on the overflow control duct 234 or any other suitable location allowing measurement of the sewage flow level. The rotation of a netting motor 240 rotating the netting 122 may be controlled according to the signal provided by the sensor 238. For example, as the sewage flow level increases the motor rotation will increase accordingly to allow the increased sewage flow to flow through the netting 122.

The liquid portion may be discarded from solid entrapping device 120 via the outlet 124 or any suitable discarding means.

In some embodiments, the trapped solid portion exiting the netting 122 may enter a trough 244 formed with walls 248 of a predetermined height. Whereupon the solid portion height does not exceed the trough wall height, the solid portion proceeds to enter a duct 250, which may be positioned at an incline to direct the solid portion into the dewatering device 128 (FIG. 2). Whereupon the solid portion height exceeds the trough wall height, the solid portion spills into a reservoir 260. The excess solid portion may remain within the reservoir 260. A sensor 264, placed on the trough 244 or any other suitable location within the sewage feedstock system 100, sensing that the incoming solid portion height is less than the predetermined height, may prompt a pump 268 to direct the solid portion from the reservoir 260, via a pipe 270 to the dewatering device 128 and thereafter to the drying device 140.

Controlling the quantity of the solid portion entering the dewatering device 128 and subsequently into the drying device 140 allows operating the drying device 140 at a constant, consistent rate also at time the rate of sewage flow into the sewage feedstock system 100 is inconsistent or fluctuating.

For example, at daytime the sewage flow rate is typically more than during the night, due to human and/or industrial activity which is mainly during daytime. In a non limiting example, the sewage flow rate during the daytime may be ten times greater than the sewage flow rate at night. At daytime the excess solid portion of the sewage may be stored within reservoir 260, thus ensuring the dewatering device 128 and the drying device 140 are not required to operate at increased speed or rate. At night, wherein the sewage amount is typically less than during the day, the stored solid portion may be pumped out of the reservoir 260 and introduced into the dewatering device 128 and the drying device 140 for processing thereof. Thus the dewatering device 128 and the drying device 140 and the other devices downstream thereof (e.g. the pellet machine 148) may operate at a relatively consistent rate during a 24 hour period regardless of the typical volume of the incoming sewage into the WWTP.

In some embodiments, the reservoir 260 may be obviated and the solid portion may flow from the netting 122 to the dewatering device 128 and/or the drying device 140 in any suitable manner.

Reference is made to FIG. 4, which depicts a pictorial illustration of the drying device 140, shown in an oppositely facing orientation to FIG. 2. A portion of the cover 306 is removed to show an inner portion of the drying device 140. As seen in FIG. 4, the drying device 140 may comprise a housing 300 including a base 302, walls 304 and a cover 306.

Within the housing 300 may be a rotation assembly 310 provided for moving and advancing the solid portion introduced therein and in some embodiments for cleaving and/or de-clumping and/or stirring and/or refining the solid portion during rotation thereof. The rotation assembly 310 may comprise at least one shaft 314 extending along the drying device 140. Each shaft 314 may be coupled to a motor 320 via gears, which rotate the shaft 314.

It is noted that the term “moving” may include any type of movement of the solid portion by the rotation assembly 310 in any direction. For example, the movement may include advancing the solid portion along a longitudinal axis of the drying device 140 such as in the orientation extending from first side 440 to the second side 444. The movement may include at least partially rotating the solid portion in the around the shaft 314. The movement may include turning the solid portion and/or stirring the solid portion, for example. The movement may include a combination thereof.

As seen in the enlargement in FIG. 4, at least one disc 326 may surround a periphery of the shaft 314. At least one disc or a plurality of discs 326 may be provided along the shafts 314. The discs 326 may be attached to the shafts 314 in any suitable manner, such as being welded thereto.

A single or plurality of paddles formed as protrusions 330 may protrude around a periphery of the disc 326. The protrusions 330 may be configured in a trapezoid-like shape or any other suitable configuration. The protrusions 330 may be attached to the discs 326 in any suitable manner, such as being welded thereto or may be formed as an integral unit.

The protrusions 330 may be positioned with an angular displacement relative to a plane of the discs 326. It is appreciated that the protrusions 330 may be positioned in any suitable manner. Additionally, each protrusion 330 may be positioned with a different angular displacement relative to another adjacent protrusion. In a non limiting example, the pitch between two adjacent protrusions 332 and 334 may be in the range of 20-25 degrees.

In the embodiment shown in FIG. 4, two shafts 314 are provided. The discs 326 and protrusions 330 of a first shaft 336 may overlap and may be alternately arranged in respect to the discs 326 and protrusions 330 of a second shaft 338. In other embodiments, any suitable number of shafts 314 may be provided.

A bar 340 may extend along on an upper section 344 of the walls 304 above the shafts 314. Rods 348 may extend from the bar 340 and may be attached thereto in any suitable manner such as by clips 350.

A scrapper 358 may be affixed to the rod 348 at a bottom portion of the rod 348 and is configured to fit in between two adjacent discs 326. The scrapper 358 may be formed generally with a pair of parallelograms 362 attached thereto at an upper edge 364 and spaced apart from each other at a bottom edge 366. Bottom edges 366 may be formed to be relatively sharp. A plurality of scrappers 358 may be provided at two oppositely facing walls 304.

The drying device 140 may comprise a heating assembly 370 provided to heat elements of the drying device 140, such as the walls 304 and the shafts 314 for drying the solid portion.

The heating assembly 370 may provide heat in any suitable manner. In some embodiments, the heating assembly 370 may comprise channels for flow of a heating medium therein. For example, the walls 304 and base 302 may be formed of an inner layer 380, typically a heat conducting material, such as steel. An intermediate layer 382 may configured as a channel designed for flow of a heating medium therein.

The heating medium described herein is water though it is appreciated that any suitable heating medium, such as a fluid including an oil, or a gas, such as air for example, may be used.

The inner layer 380 is heated by the hot water and thus is configured to heat and thereby dry the solid portion within the drying device 140. An external layer 388 may be formed of thermally insulating material to ensure that heat remains within the drying device 140. Additional channels comprising chambers 390 for flow of heated water at base 302 may be provided.

In addition to heating the walls 304 and base 302, the shafts 314 may be configured with a channel comprising a thoroughgoing bore (not shown) designed to receive heated water therein from a water inlet 396. The heated water may flow thorough the bore and exit in any suitable manner, such as via an outlet (not shown). The heated water flowing through the shafts 314 heats the shafts 314 which in turn heats the discs 326 and protrusions 330, thus heating and drying the solid portion coming in contact therewith.

The cover 306 may comprise the inlet 142 (FIG. 2) for allowing the solid portion therein and a plurality of ports 404 for allowing escape of humidity thereout. In some embodiments the ports 404 may be enclosed by enclosures 408 for capturing steam therein to be removed therefrom in any suitable manner, such as by releasing the steam out of the sewage feedstock system 100.

At least a section 410 of the cover 306 may be formed in a generally roof-like shape so as to allow heat to rise above the rotation assembly 310 during operation of the drying device 140, thereby preventing condensation of the heat on the rotation assembly 310. A section 412 (FIG. 2) of the cover 306 may be formed with a generally flat surface for allowing an additional device, such as the dewatering device 128, to be mounted thereon for treating the sewage prior to entering the drying device 140.

The cover 306 may be provided with handles 414 to allow the cover 306 to be removed for maintenance purposes. The cover 306 may be formed of any suitable material, such as stainless steel.

The drying device 140 may be formed of a plurality of modular segments, such as a first segment 420 and a second segment 422, so as to allow the drying device 140 to be constructed according to a desired length.

The desired length may be determined according to the space allowed in a WWTP, or, for example, according to a desired dryness degree, such that the longer the drying device 140 is formed, the longer the sewage dried therein remains within the drying device 140 and thus exits at a dryer state.

A plurality of supporting legs 430 may support the housing 300. The legs 430 may be configured with adjustable screws 434 for height adjustability thereof.

During operation, the solid portion may enter the drying device 140 via the inlet 142. The solid portion is advanced by the rotation assembly 310 along the shafts 314 due to rotation of the shafts 314, and in turn rotation of discs 326 and protrusions 330. As the solid portion is moved by rotation assembly 310, the solid portion comes in contact with the heated walls 304, shafts 314, discs 326 and protrusions 330 and is thus dried. The environment within housing 300 is maintained relatively dry due to the escape of humidity via ports 404. In a non-limiting example, the dryness may be maintained at a relative humidity of in the range of 10-45%. During the rotation of the shafts 314 the scrapers 358 remove accumulated solids of the solid portion off the shafts 314.

The drying device 140 is configured with features to enable selection of a desired dryness degree of the solid portion therein. These features may include, inter alia, the temperature of the heating medium, e.g. the water, and the duration the solid portion remains within the drying device 140. The longer the duration of the solid portion within the drying device 140, the greater the dryness degree of the solid portion. The duration may be determined, inter alia, by any one of the following factors: (i) an angular displacement of the drying device 140 relative to the ground. The height of the legs 430 may be adjusted, thereby angularly displacing the drying device 140 relative to the ground. For example, the legs 430 supporting a first side 440 of the drying device 140 may be positioned to be higher than legs 430 supporting a second side 444 of the drying device 140. Thus the solid portion will be moved faster within the angularly displaced drying device 140 than in a drying device 140 parallel to the ground. In a non-limiting example, the angular displacement may be 0.5 degrees; (ii) the rotation of the shafts 314. The higher the rotational speed of the shafts 314, the solid portion will be moved faster within the drying device 140. Additionally, rotation of both shafts 314 may cause the solid portion to be moved faster within the drying device 140, while rotation of a single shaft 314 may slow down the movement of the solid portion. Moreover, the rotation orientation of the shafts 314 may determine the duration of the solid portion within the drying device 140. For example, wherein the two shafts 314 rotate in mutually opposite orientations the solid portion may be moved faster within the drying device 140 than wherein the two shafts 314 rotate in the same orientation; (iii) the angular displacement of the protrusions 330. The greater the angular displacement of the protrusions 330 relative to the plane of the discs 326 and/or to each other, the slower the solid portion will be moved within the drying device 140.

In some embodiments, the angular displacement of the protrusions 330 may vary along the drying device 140. For example, the angular displacement of the protrusions 330 at the first side 440 may be greater than the angular displacement at the second side 444. Thereby the duration of the solid portion at the first side 440 is longer than at the second side 444. Thus, the solid portion is heated for a longer duration at the first side 440, proximate to the inlet 400, wherein the solid portion is wetter, than at the second side 444, wherein the solid portion is dryer and a lengthy heating duration may be redundant.

In addition to advancing the solid portion along the drying device 140, the rotation of the protrusions 330 and discs 326 and scrapping of scrapers 358 with sharp edges 366 may de-clumps particles of the solid portion, which may tend to agglomerate. The tendency to agglomerate may be augmented due to a relatively high oleaginous content of the solid portion. In a non-limiting example the oleaginous content of the solid portion may be 15% or less. In a non-limiting example the oleaginous content of the solid portion may be 30% or less.

Additionally, fibers within the solid portion may be de-clumped and/or cleaved as the protrusions 330 rotate and the sharp edged scraper 358 scrapes the solids. De-clumping the agglomerates of the solid portion and possible cleaving of the fibers increases a surface area of the particles of the solid portion and thereby increases the contact of the particles with heat emitted from the walls 304, the shafts 314, the discs 326 and the protrusions 330. The cleaving may be performed on relatively large solids entering the drying device 140, such as branches, cloths and moist towelettes. In a non-limiting example these large solids may comprise a size large than 1 cm.

Additionally, de-clumping the fibers and agglomerates of the solid portion increases the homogeneity of the solid portion, therefore resulting in a superior cellulosic feedstock.

The drying device 140 is configured for drying the solid portion and is thus designed with the discs 326 and the protrusions 330 for increasing the surface area of the drying device. The increased surface area augments the drying efficiency of the drying device 140 since the contact of the solid portion with the surface area of the drying device 140 increases thereby increasing the heat transfer area of transferring heat from the drying device 140 to the solid portion.

In a non limiting example, the surface area of the average fiber with the cellulosic feedstock produced by the systems and methods of the disclosure may be the area of a spherical particle with a diameter in the range of 0.01 μm-100 mm. In a non limiting example, the average volumetric density of the processed solid portion entering the drying device 30 may be in the range of 0.5-0.9 grams/milliliter and may exit the drying device 30 with an average volumetric density of 0.1-0.3 grams/milliliter. Thus it is seen that the surface area has increased (such as twofolds or even threefolds) as the volumetric density has decreased.

The drying device 140 may be configured to stir the solids therein due to the rotation of the protrusions 330 and discs 326 and scrapping of scrapers 358. The solid portion entering the drying device 140 may comprise an inhomogeneous mixture of solids. The stirring action of the rotation assembly 310 may mix the solid mixture to achieve a more homogeneous solid portion and accordingly, homogeneous feedstock.

In some embodiments, the rotation assembly 310 may refine the fibers of the solid portion within the drying device 140. Refining may comprise increasing the common directionality of the fibers. The fibers entering the drying device 140 may be scattered and arranged in multiple, arbitrary directions. The rotation device 310, which rotates all the fibers therein in the same direction, may force the fibers therein to be arranged in the same directions. The common directionality of the fibers allows for producing superior feedstock. For example, paper produced from feedstock with increased directionally is superior to paper produced from scattered fibers.

Refining may comprise flattening and compressing the fibers. Compressing the fibers may be performed by the heat assembly 370 drying the liquids adsorbed to the fibers and/or by the rotation assembly 310 which moves and presses the fibers. Thus the feedstock produced from refined, compressed fibers is superior.

The drying device 140 is configured for drying various types of solids. Due to the rotation assembly 310 and heating assembly 370, the drying device 140 is suitable for drying particles with a relatively small diameter that are susceptible to dispersion when excess pressure is exerted thereon. For example, powders and granules may be dried within the drying device 140 without dispersing into the air as opposed to the common practice in the industry of drying them within blow-dryers. In a non limiting example, the particles with a relatively small diameter may comprise an average diameter of approximately one p.m. In a non limiting example, the particles with a relatively small diameter may comprise an average diameter of approximately 80 μm. In a non limiting example, the particles with a relatively small diameter may comprise an average diameter of approximately 100 μm.

Additionally, due to the de-clumping and/or cleaving of the rotation assembly 310, the drying device 140 is suitable for drying particles with a tendency to agglomerate, such as particles with a relatively high oleaginous content.

In some embodiments, the drying device 140 is configured with the rotation assembly 310 and heating assembly 370 for drying the solid portion and moving fibers in the solid portion. In some embodiments, the drying device 140 is configured for drying the solid portion and moving fibers in the solid portion simultaneously, since both the rotation assembly 310 and heating assembly 370 are embodied in the drying device 140.

According to some embodiments, the drying device 140 may be used for feedstock production from fibers, such as fibers in the solid portion of the flowing sewage in addition to fibers originating from other sources, such as vegetation, paper and plastics. The drying device 140 may be formed with the inlet 142 for allowing the fibers into the drying device 140. In some embodiments, the fibers entering the drying device 140 may comprise a dryness degree in the range of approximately 5%-50%. Generally the drying device 140 may comprise a rotation assembly configured to move the fibers and a heating assembly to provide heat to the fibers for drying thereof and being configured to dry the fibers to a dryness degree in the range of approximately 70%-99%. In some embodiments, the rotation assembly and the heating assembly may comprise the rotation assembly 310 including the shafts 314, the discs 326, protrusions 330 and scrapers 358 and the heating assembly may also comprise the heating assembly 370.

The operational parameters of the drying device 140 may be controlled by the controller 170 (FIG. 2) or any other suitable control functionality. The operational parameters may include, inter alia: the temperature of the walls 304 and the shafts 314; the rotational speed of the shafts 314; the rotation orientation of the shafts 314; the angular displacement of the protrusions 330; and the height of each of the legs 430. These operational parameters may be manually controlled by a human operator, or automatically controlled and/or remotely controlled from a remote location.

In accordance with one embodiment, the operational parameters of the drying device 140 may be determined prior to operation thereof. In accordance with another embodiment, the operational parameters may be adjusted during operation, manually or automatically such as by control of the controller 170. In a non-limiting example, the rotation speed of the shafts 314 may be automatically controlled according to the amount of the solid portion entering the drying device 140. For example, at night wherein the sewage amount is typically less than during the day, the rotational movement of the rotation assembly 110 may be decreased.

The drying device 140 may include sensors 450 for sensing the operational parameters and transmitting a signal to the controller 170, which in turn may adjust the operational parameters as desired. The sensors 450 may include, for example, temperature and humidity sensors placed proximate to the inlet 142 and the outlet 144 (FIG. 2).

Reference is made to FIGS. 5 and 6 which depict pictorial illustrations of the pellet machine 148 and the heat transfer assembly 160. In some embodiments, a fraction of the pellets may be directed from the pellet machine 148, via the conveyer 158, to a container 500 for transferring the pellets to an oven 510 of the heat transfer assembly 160. The pellets are combusted in the oven 510 to produce thermal energy. The efficiency for producing thermal energy from the pellets may be relatively high, as almost all the combusted pellets are converted into thermal energy. The thermal energy is used to heat a heat medium such as water, which may be transferred or circulated, via insulated pipes 516, to the drying device 140 (FIG. 4) for heating thereof to dry the solid portion therein.

An additional backup oven 517 may be provided in case the oven 510 is inoperative or in case there is need for additional combustion beyond the capacity of the oven 510. The backup oven 517 may be employed at the commencement of operation of the sewage feedstock system 100 to produce an initial batch of feedstock for combustion thereof in the oven 510. In some embodiments the oven 517 may be a diesel oven.

In some embodiments, the water may flow from the oven 510 to the drying device 140 and back via pipes 518 in a generally continuous, closed loop for repeated heating by the heat from the oven 510. Thereby the water temperature is substantially maintained at a relatively high temperature during operation of the drying device 140. In a non-limiting example the relatively high temperature may be in the range of 50-95° C.

In some embodiments the water flowing in pipe 516 and/or in pipe 518 may flow through a heat exchanger tank 520. The relatively hot water flowing through pipes 516 and/or 518 may heat a heating element such as a coil (not shown) within the heat exchanger tank 520. An inlet 530 may direct water from a water grid into the heat exchanger tank 520. The heating element may heat the grid water, which may enter at an ambient temperature, to an elevated temperature. The now heated grid water may flow via an outlet 534 from the heat exchanger tank 520 to flush the netting 122 for cleaning and de-clogging thereof. In a non-limiting example the relatively hot water may be in the range of 50-95° C. In a non-limiting example, the relatively hot water may increase the temperature of the grid water by at least 20-45° C.

In some embodiments the heat exchanger tank 520 may be obviated and the netting 122 may be cleaned in any suitable manner.

The ash formed by combustion of the pellets within the oven 510 may be collected and transferred via a conveyer, or any other suitable means, to an ash collection tank. The ash may be used for any suitable application, such as for fertilizing, for example.

It is appreciated that producing the cellulosic feedstock using the sewage feedstock system 100 provides for a plurality of superior benefits, as described in reference to the sewage feedstock system 10. Additionally, as seen from FIG. 2, although the sewage feedstock system 100 comprises multiple components, such as the drying device 140 and the dewatering device 128, the components are arranged in a compact configuration, thereby minimizing the floor space of the sewage feedstock system 100. This compact arrangement allows the sewage feedstock system 100 to be installed in a variety of sewerage waste systems, and even in relatively small sized locations. Additionally, the sewage feedstock system 100 treats the sewage and may thus replace standard sewage treatment within a standard WWTP. The sewage feedstock system 10 or 100 may be compactly designed in a small space. This significantly decreases the land area or footprint required for wastewater treatment. In a non-limiting example, the footprint of a standard WWTP of a city with a population of 5000-30000 inhabitants is 5-20 acres, respectively, while the footprint of the sewage feedstock system 10 or 100 serving the same city may be 50 square meters.

Moreover, the sewage feedstock system 100 may be configured such that it consumes thermal energy for heating the drying device 140 and heating grid water for cleaning the netting 122. In some embodiments, the thermal energy may be supplied by combustion of the pellets in the oven 510. Thus the thermal energy used for operating the sewage feedstock system 100 may be supplied by the sewage feedstock system 100 itself, without requiring any further energy investment from an external source. Accordingly, the energy required to operate the sewage feedstock system 100 is significantly reduced. In a non-limiting example, the amount of heat required to treat sewage with a solid portion of 25 kilos in the sewage feedstock system 100 is 60 kWh. That heat may be supplied by the sewage feedstock system 100 itself.

Additionally, utilizing the heat exchanger tank 520 for heating the grid water for cleaning the netting 122, significantly reduces the energy load required to operate the sewage feedstock system 100. In a non-limiting example, the amount of heat required to heat the grid water to clean the netting 122 in a sewage feedstock system 100 treating sewage with a solid portion of 25 kilos, is 6 kWh. That heat may be supplied by the sewage feedstock system 100 itself.

Another advantageous feature of the sewage feedstock system 100 is the control and regulation of the amount of sewage or solid portion introduced into the sewage feedstock system 100 and into the devices thereof. As described above, the sewage feedstock system 100 may comprise the reservoir 260 for storing excess solid portion from the sewage therein. The dewatering device 128 and the drying device 140 may operate at a relatively consistent rate regardless of the volume of the incoming sewage into the WWTP. Additional features configured for regulating and controlling the flow of the sewage in the sewage feedstock system 100 may be the flow control subassembly 184 and the various sensors described herein. Sewage, in the course of its routine flow, flows in an inconsistent rate. For example, as described above, the amount of sewage at daytime is greater than at night. Additionally, the amount of liquid in the sewage is greater during rainfall season than dryer seasons. Therefore regulating and controlling the sewage and/or solid flow within the sewage feedstock system 100 is of great importance in a sewage feedstock system 100, as the inconsistent volume and rate of sewage and solids may be regulated and the sewage feedstock system 100 may operate at a consistent, controlled rate, thus rendering the sewage feedstock system 100 efficient.

Another advantageous feature of the sewage feedstock system 100 is that the sewage feedstock system 100 may be modularly configured to be adapted to the requirements of a specific sewerage waste system. The drying device 140 is configured with modular segments so as to allow the drying device 140 to be constructed according to a desired length. A longer drying device 140 is capable of processing a larger amount of sewage therein. Therefore in a sewerage waste system, such as a municipal waste system of a highly populated city, the sewage feedstock system 100 will be configured with a longer drying device 140 than the drying device 140 in a sewerage waste system of an unpopulated, rural location. Additionally, the quantity of sand and other particles within the sewage may vary in accordance with the climate of the sewage waste system location. Accordingly, the components of the sewage feedstock system 100 may be adapted. For example, the undesired particle removal device 18 or sand removal device 110 may be larger or with increased removal capacity in sandy climates than in non-sandy climates

In the use of the sewage feedstock system 100, some of the devices described in the disclosure may be obviated. Alternatively, or in addition, the order of operating the devices within sewage feedstock system 100 may be altered without compromising the quality of the produced cellulosic feedstock.

Example embodiments of the devices, systems and methods have been provided in this disclosure. These embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and devices which may further include any and all elements from any other disclosed methods, systems, and devices, including any and all elements corresponding to translocation control. Elements from one or another disclosed embodiments may be interchangeable with elements from other disclosed embodiments. In addition, one or more features/elements of disclosed embodiments may be removed and still result in patentable subject matter (and thus, resulting in yet more embodiments of the subject disclosure).

1-58. (canceled)

59. A drying device for feedstock production from fibers, comprising:
an inlet for allowing the fibers into the drying device;
a rotation assembly configured to move the fibers;
a heating assembly configured to provide heat to the fibers for drying thereof, said heating assembly comprising at least one channel for flow of a heating medium therethrough.

60. A drying device according to claim 59, further comprising at least one shaft and a least one disc along the shaft and wherein the disc is formed with protrusions protruding around a periphery of the disc.

61. A drying device according to claim 60 wherein a protrusion is positioned with a different angular displacement relative to another adjacent protrusion.

62. A drying device according to claim 59 wherein the rotation assembly further comprises scrapers for scrapping the fibers off the shaft.

63. A drying device according to claim 59 wherein the heating assembly comprises at least one shaft formed with a bore defining the channel for flow of the heat medium therein.

64. A drying device according to claim 59, wherein the heating assembly and rotation assembly are configured for drying the fibers and moving the fibers simultaneously.

65. A drying device according to claim 59, wherein the heating assembly and rotation assembly comprise at least one shaft, and wherein moving the fibers comprises at least one of advancing the fibers along the shaft and at least partially rotating the fibers around the shaft.

66. A drying device according to claim 59, wherein the rotation assembly is configured to perform at least one of the following: de-clump the fibers therein, stir the fibers therein, refine the fibers therein, and cleave the fibers therein.

67. A drying device according to claim 59, wherein the fibers are from sewage flowing from a municipal waste water treatment plant.

68. A drying device according to claim 59, wherein the fibers are dried in the drying device to produce feedstock therefrom.

69. A drying device according to claim 59, wherein the feedstock is a cellulosic feedstock containing a cellulose content in the range of least 50-95% or more.

70. A system for feedstock production from flowing sewage, comprising:
an inlet for flow of the flowing sewage therein, the sewage comprising a solid portion and a liquid portion, said solid portion including fibers;
a solid entrapping device for separating the solid portion from the liquid portion; and
a drying device configured for drying and moving the solid portion, thereby producing a feedstock.

71. A system according to claim 70, further comprising any one of the following:
an undesired particle removal device for removal of undesired particles from the flowing sewage,
a dewatering device for removal of water from the solid portion, or
a pellet machine for forming pellets from the feedstock.

72. A system according to claim 70 wherein the feedstock is produced by mechanical processes.

73. A system according to claim 70 wherein the feedstock comprises a portion of at least 70% organic materials.

74. A system according to claim 70, wherein the feedstock is a cellulosic feedstock containing a cellulose content in the range of least 50-95% or more.

75. A system according to claim 70 wherein the drying device utilizes heat for drying the solid portion and the heat is supplied by combustion of a fraction of the feedstock produced by the system.

76. A system according to claim 70 wherein the solid entrapping device comprises a netting and the netting is cleaned by heated water and the water is heated by heat supplied by combustion of a fraction of the feedstock produced by the system.

77. A system according to claim 76 further comprising a heat exchanger and wherein the heat supplied by combustion of the fraction of the feedstock increases a temperature of water flowing into the drying device, the heated drying device water flows into the heat exchanger to increase the temperature of the water for cleaning the netting.

78. A method for producing feedstock from sewage, comprising:
providing sewage, the sewage comprising a solid portion and a liquid portion, said solid portion including fibers;
separating the solid portion from the liquid portion; and
drying the solid portion and moving the solid portion, thereby producing a feedstock.
